(19) United States
(12) Patent Application Publication
(10) Pub. No.: US 2026/0357531 A1
(43) Pub. Date: Nov. 12, 2026

(54) LID FOR UNDERGROUND STRUCTURE, GAS VENTING SYSTEM, AND METHOD FOR CONSTRUCTING GAS VENTING SYSTEM

(71) Applicant: NTT, Inc., Tokyo (JP)

(72) Inventors: Takuya ISHIKAWA, Tokyo (JP); Koji ITASAKA, Tokyo (JP); Toshimitsu IZUMI, Tokyo (JP); Daisaku NISHIYAMA, Tokyo (JP)

(73) Assignee: NTT, Inc., Tokyo (JP)

(21) Appl. No.: 19/100,184

(22) PCT Filed: Aug. 3, 2022
(86) PCT No.: PCT/JP2022/029858

§ 371 Date: Jan. 31, 2025

(51) Int. Cl. E02D 29/14; F17C 7/00; F17D 1/04

(52) U.S. Cl. CPC E02D 29/1436; F17C 7/00; F17D 1/04; F17C 2205/0352; F17C 2221/012; F17C 2270/0136

(57) ABSTRACT

A lid (102) for an underground structure according to the present disclosure includes: a main body portion (1) that covers an opening provided in an underground structure (101) and communicating an underground space (S1) with a ground space (S2), and defines a through-hole (HL) penetrating the main body portion (1); and a small lid (2) with flexibility that is disposed in the through-hole (HL) so as to come into pressure contact with an inner surface of the main body portion (1) that defines the through-hole (HL).

### TECHNICAL FIELD

The present disclosure relates to a lid for an underground structure, a gas exhaust system, and a gas exhaust system construction method.

### BACKGROUND ART

In recent years, for the purpose of achieving carbon neutrality by decarbonization and in order to utilize hydrogen (gaseous hydrogen), a method for supplying hydrogen and the safety in supplying hydrogen have been studied (see NPL 1).

There has been known a configuration in which a gas pipeline for supplying hydrogen is directly buried in the ground, but in this configuration, if the hydrogen leaks from the gas pipeline, the leaked hydrogen diffuses into the soil. For this reason, laying a gas pipeline in an underground space defined by an underground structure such as a maintenance hole has been studied. It is also known that a sensor provided in an underground space detects leakage of hydrogen from a gas pipeline.

### CITATION LIST

### Non Patent Literature

[NPL 1] Tetsushi Morita, “Approaches to Gas Pipeline Supply in City Gas Industry,” Journal of the Institute of Electrical Installation Engineers of Japan, Vol . 36, No. 4, P. 242-245, 2016.

### SUMMARY OF INVENTION

### Technical Problem

However, when gas leaks from the gas pipeline in an underground space defined by underground structures, the leaked gas is accumulated in a pipeline that communicates the plurality of underground structures with each other. For example, in a configuration in which the gas is hydrogen, there is a risk that explosion or the like occurs when the gas reaches a constant concentration. Further, it is required to repair damage or the like of a gas pipeline which causes gas leakage, but it takes time to reduce the concentration of the gas after the gas leakage is detected by a sensor and the gas supply is stopped, and the worker cannot enter the underground space until then. Therefore, it is necessary to discharge the gas leaked into the underground space at an early stage.

An object of the present disclosure made in view of such circumstances is to provide a lid for an underground structure, a gas exhaust system, and a gas exhaust system construction method, which quickly exhaust gas leaked from a gas pipeline into an underground space.

### Solution to Problem

In order to solve the above problem, a lid for an underground structure according to the present disclosure includes: a main body portion that covers an opening provided in an underground structure and communicating an underground space with a ground space, and defines a through-hole penetrating the main body portion; and a small lid with flexibility that is disposed in the through-hole so as to come into pressure contact with an inner surface of the main body portion that defines the through-hole.

In order to solve the above problem, a gas exhaust system according to the present disclosure includes an underground structure and a lid for an underground structure, wherein the lid for an underground structure includes: a main body portion that covers an opening provided in the underground structure and communicating an underground space with a ground space, and defines a through-hole penetrating the main body portion; and a small lid with flexibility that is disposed in the through-hole so as to come into pressure contact with an inner surface of the main body portion that defines the through-hole.

In addition, in order to solve the above problem, a gas exhaust system construction method according to the present disclosure includes the steps of: constructing a gas pipeline that conveys gas from a supply-side gas tank to a consumption-side gas tank, the gas pipeline being partially disposed in a pipeline that communicates a plurality of underground structures with underground spaces defined by the plurality of underground structures respectively; and arranging the lid for an underground structure described above in an opening provided in each of the plurality of underground structures and communicating the underground spaces with a ground space.

### Advantageous Effects of Invention

According to the lid for an underground structure, the gas exhaust system, and the gas exhaust system construction method according to the present disclosure, the gas that has leaked from the gas pipeline into the underground spaces can be quickly exhausted.

### BRIEF DESCRIPTION OF DRAWINGS

FIG. 1 is a schematic diagram of a gas exhaust system according to a present embodiment of the present disclosure.

FIG. 2A is a top view schematically showing an example of a lid for an underground structure shown in FIG. 1.

FIG. 2B is an AA cross-sectional view schematically showing the lid for an underground structure shown in FIG. 2A.

FIG. 3 is a perspective cross-sectional view showing a part of another example of the lid for an underground structure shown in FIG. 1.

FIG. 4 is a perspective view showing an inner lid shown in FIG. 3.

FIG. 5 is a perspective view showing an outer lid shown in FIG. 3.

FIG. 6 is a perspective cross-sectional view showing a state in which a small lid is removed from the lid for an underground structure shown in FIG. 3.

FIG. 7 is a flowchart showing an example of processing for constructing the gas exhaust system shown in FIG. 1.

FIG. 8 is a flowchart showing an example of operations of the gas exhaust system shown in FIG. 1.

### DESCRIPTION OF EMBODIMENTS

### Configuration of Gas Exhaust System

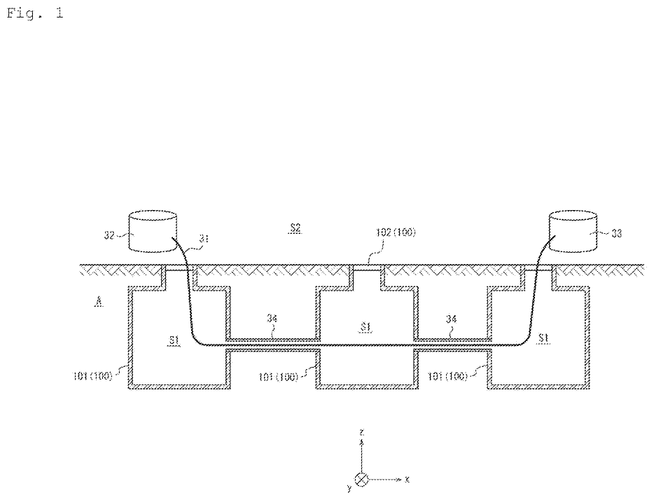

An overall configuration of the present embodiment will be described with reference to FIG. 1. FIG. 1 is a schematic diagram of a gas exhaust system 100 according to the present embodiment.

As shown in FIG. 1, the gas exhaust system 100 according to the present embodiment includes an underground structure 101 and a lid 102 for an underground structure.

The underground structure 101 is provided underground A and defines an underground space S1. The underground structure 101 can be a maintenance hole, a tunnel, a hand hole, or the like. A part of a gas pipeline 31 is disposed in the underground space S1.

One of ends of the gas pipeline 31 is connected to a supply port of a supply-side gas tank 32, and is provided in such a manner that gas supplied from the supply-side gas tank 32 is supplied to the gas pipeline 31 from said end. The other end of the gas pipeline 31 is connected to a receiving port of a consumption-side gas tank 33, and is provided in such a manner that the gas supplied from the supply-side gas tank 32 and transported through the gas pipeline 31 is caused to flow into the consumption-side gas tank 32 through the receiving port. Therefore, the gas pipeline 31 includes the supply port of the supply-side gas tank 32, a ground space S2, the underground space S1, a pipeline 34 for communicating underground spaces S1 with each other, and the receiving port of the consumption-side gas tank 33. The gas described in the present embodiment is, for example, hydrogen, but is not limited to hydrogen. In a configuration in which the gas is hydrogen, the gas pipeline 31 is a hydrogen pipeline, the supply-side gas tank 32 is a supply-side hydrogen tank, and the consumption-side gas tank 32 is a consumption-side hydrogen tank.

The lid 102 for an underground structure has a main body portion 1 and a small lid 2.

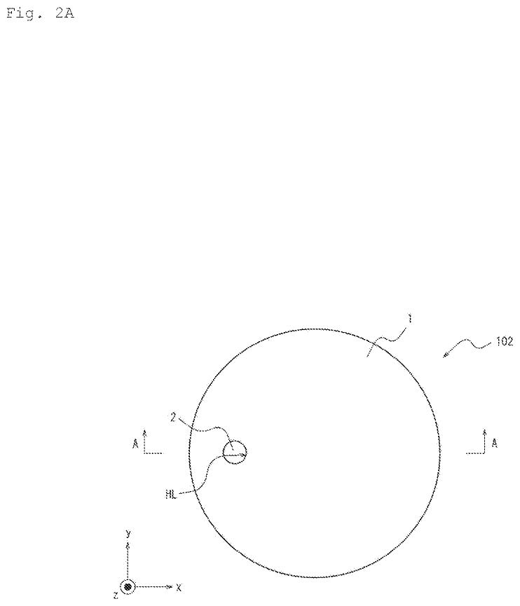

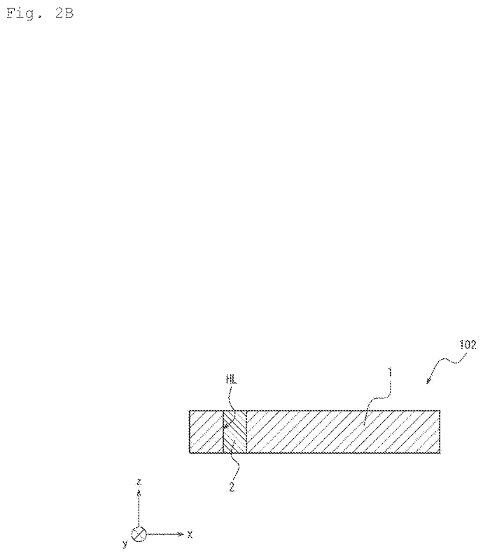

The main body portion 1 is a member provided in the underground structure 101 and covering an opening that communicates the underground space S1 with the ground space S2. In the examples shown in FIGS. 2A and 2B, the main body portion 1 has a plate surface shape, and the plate surface is circular. The main body portion 1 defines a through-hole HL penetrating the main body portion 1.

In one example, as shown in FIG. 2B, the through-hole HL may have a cylindrical shape.

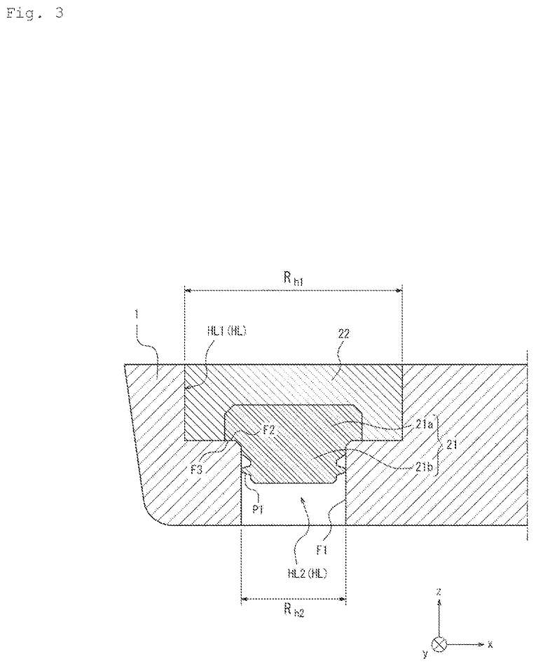

In another example, as shown in FIG. 3, the through-hole HL may include a first through-hole portion HL1 having a hole diameter (first hole diameter) Rₕ₁, and a second through-hole portion HL2 adjacent to the first through-hole portion HL1 in a penetration direction (z-axis direction in FIG. 3) and having a diameter (second hole diameter) Rₕ₂ shorter than the hole diameter Rₕ₁. In such a configuration, in a state where the main body portion 1 is disposed in an opening of the underground structure 101, the first through-hole portion HL1 is located on the ground space 82 side, and the second through-hole portion HL2 is located on the underground space S1 side. Each of the hole diameters Rₕ₁ and Rₕ₂ can be set to a length so that the lid 102 for an underground structure has a predetermined strength or more, The predetermined strength refers to strength at which the underground space S1 can be blocked without causing damage by a pressure assumed to be received from the ground space S2 side.

The main body portion 1 may define a gas pipeline through-hole that penetrates the main body portion 1 to allow the insertion of the gas pipeline 31 therethrough from the underground space S1 to the ground space S2.

The small lid 2 is disposed in the through-hole HL so as to come into pressure contact with an inner surface of the main body portion 1 that defines the through-hole HL. The small lid 2 has flexibility. For example, the small lid 2 may be formed of rubber.

As shown in FIG. 3, in a configuration in which the through-hole HL penetrating the main body portion 1 has the first through-hole portion HL1 and the second through-hole portion HL2, the small lid 2 may include an inner lid 21 and an outer lid 22. The inner lid 21 and the outer lid 22 each have flexibility.

The inner lid 21 is disposed in the second through-hole portion HL2 so that at least a part of the inner lid 21 comes into pressure contact with an inner surface F1 of the main body portion 1 that defines the second through-hole portion HL2.

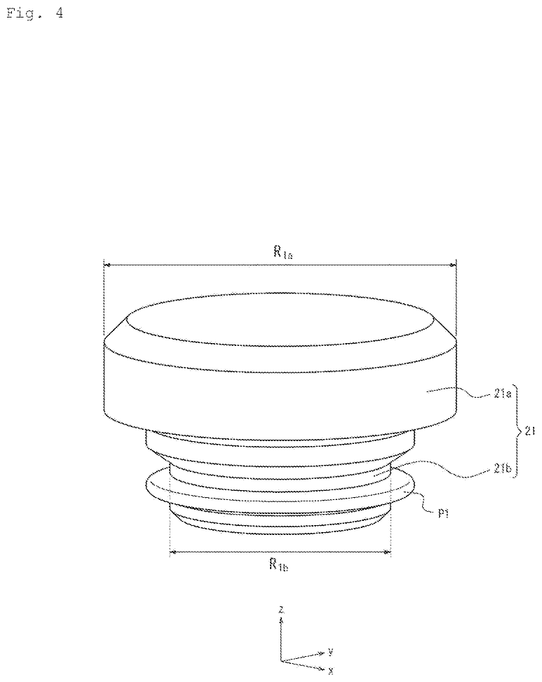

As shown in FIG. 4, the inner lid 21 may include a first inner lid portion 21a and a second inner lid portion 21b.

The first inner lid portion 21a has a diameter (first diameter) R₁ₐ (see FIG. 4) shorter than the hole diameter Rₕ₁ and longer than the hole diameter Rₕ₂, and is disposed in the first through-hole portion HL1, as shown in FIG. 3.

The second inner lid portion 21b is provided integrally with the first inner lid portion 21a adjacently to the first inner lid portion 21a in the penetration direction. The second inner lid portion 21b is disposed in the second through-hole portion HL2 so as to come into pressure contact with the inner surface F1 of the main body portion 1 that defines the second through-hole portion HL2. For example, a diameter R_{1b} (see FIG. 4) of the second inner lid portion 21b can be made larger than the hole diameter Rₕ₂ (see FIG. 3) in a state where the second inner lid portion 21b is not inserted into the second through-hole portion HL2, and can be made equal to the hole diameter Rₕ₂ in a state where the second inner lid portion 21b is compressed and inserted into the second through-hole portion HL2.

As shown in FIG. 3, the first inner lid portion 21a is disposed in the first through-hole portion HL1, with the opposite side of the second inner lid portion 21b facing the ground space S2, and the second inner lid portion 21b is disposed in the second through-hole portion HL2. Thus, a surface F2 of a part of the first inner lid portion 21a on the underground space S1 side where the second inner lid portion 21b is not provided comes into pressure contact with a surface F3 of the main body portion 1 on the side facing the ground space S2, the surface F3 defining the first through-hole portion HL1. Thus, the first inner lid portion 21a can be prevented from being pushed out to the underground space S1 side by a pressure coming from the ground space S2 side.

In addition, as shown in FIG. 4, a flexible projection (first projection) P1 may be provided on a side surface of the second inner lid portion 21b in a direction orthogonal to the penetration direction. The projection P1 has such a size and shape as to press a side face F1 of the main body portion 1 that defines the second through-hole portion HL2, in a state where the second inner lid portion 21b is inserted into the second through-hole portion HL2. The size and shape of the projection P1 are appropriately determined in accordance with the diameter R_{1b} of the second inner lid portion 21b, the flexibility of the material forming the second inner lid portion 21b, and the pressure by the gas obtained when the second inner lid portion 21b is removed from the second through-hole portion HL2.

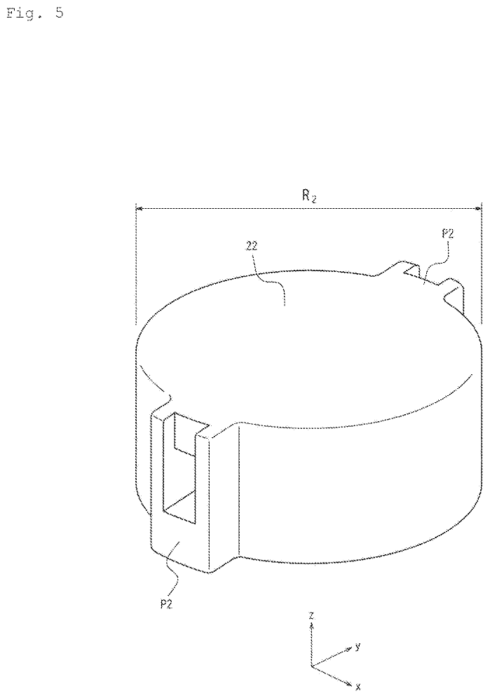

The outer lid 22 covers the first through-hole portion HL1 side in the inner lid 21 and is disposed in the first through-hole portion HL1. For example, as shown in FIG. 3, the outer lid 22 may be disposed inside the first through-hole portion HL1 so as to come into pressure contact with an inner surface of the main body portion 1 that defines the first through-hole portion HL1. Specifically, a diameter R₂ (see FIG. 5) of the outer lid 22 can be made larger than the hole diameter Rₕ₁ (see FIG. 3) in a state where the outer lid 22 is not inserted into the first through-hole portion HL1, and can be made equal to the hole diameter Rₕ₁ in a state in which the outer lid 22 is compressed and inserted into the first through-hole portion HL1. The outer lid 22 is disposed so that a recessed portion side faces the underground space S1. Thus, the outer lid 22 covers the first inner lid portion 21a in a state of being disposed in the first through-hole portion HL1. Since the outer lid 22 has flexibility, as described above, when a vehicle or the like passes the lid 102 for an underground structure on the ground space S2 side, the lid is bent when a load is applied, and thereby the load applied to the inner lid 21 can be reduced.

As shown in FIG. 5, a flexible projection (second projection) P2 may be provided on an outer peripheral surface of the outer lid 22 in a direction orthogonal to the penetration direction. Specifically, in a configuration in which the outer lid 22 is in pressure contact with the inner surface of the main body portion 1 that defines the first through-hole portion HL1, the projection P2 may be further provided, or the outer lid 22 may be provided in such a manner that the outer lid 22 itself does not come into pressure contact with the inner surface of the main body portion 1 that defines the first through-hole portion HLI but the projection P2 comes into pressure contact with said inner surface. The shape of the projection P2 may be any shape and may be formed according to the flexibility of the outer lid 22 so that the projection P2 and the outer lid 22 can be compressed and disposed in the first through-hole portion HL1. The projection P2 may have a shape having a recessed portion inside.

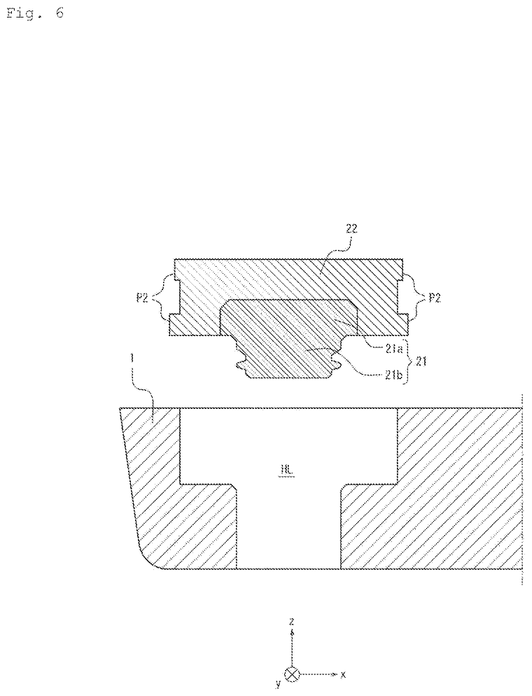

Thus, when the pressure of the gas in the underground space S1 pushing the inner lid 21 is not higher than the atmospheric pressure of the ground space $2 by a predetermined value or more, the position of the inner lid 21 is kept, and the closed state of the underground space S1 is kept. When the pressure of the gas in the underground space S1 pressing the inner lid 21 is higher than the atmospheric pressure of the ground space S2 by the predetermined value or more, as shown in FIG. 6, the inner lid 21 is pushed out to the ground space S2 side and the outer lid 22 is pushed to the ground space S2 side. In this case, since the inner lid 21 is pushed to the outside of the second through-hole portion HL2 and the outer lid 22 is pushed to the outside of the first through-hole portion HL1, the underground space S1 and the ground space S2 communicate with each other, and the closed state of the underground space S1 is opened. The predetermined value is a minimum value of the pressure at which the gas in the underground space S1 pushes the inner lid 21 when the small lid 2 is pushed out to the ground space S2 side and the underground space S1 and the ground space S2 are communicated with each other, and the predetermined value is determined in accordance with the weights, materials, shapes, and the like of the inner lid 21 and the outer lid 22.

### Construction of Gas Exhaust System

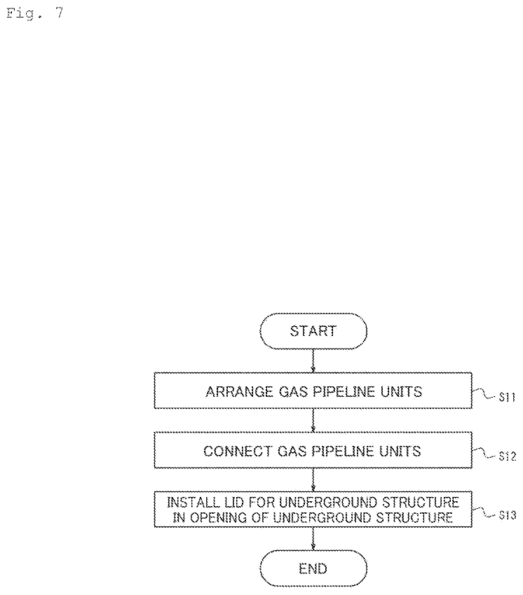

Here, the construction of the gas exhaust system 100 according to the present embodiment will be described with reference to FIG. 7. FIG. 7 is a sequence diagram showing an example of a method for constructing the gas exhaust system according to the present embodiment.

First, in steps S11 and S12, the gas pipeline 31 is constructed for conveying gas from the supply-side gas tank 32 to the consumption-side gas tank 33, the gas pipeline 31 being partially disposed in the pipeline 34 for communicating the plurality of underground structures 101 and underground spaces S1 defined by the respective underground structures 101 with each other.

Specifically, in step S11, each of a plurality of gas pipeline units, which are bendable hollow tubes, is disposed in a plurality of pipelines 34 through the underground structures 101 In doing so, it is desirable that no fixed objects such as cables are provided in the pipelines 34 in which the gas pipeline units are disposed. One of ends of one of the gas pipeline units is attached to the supply port of the supply-side gas tank 32, and one of ends of the other gas pipeline unit is attached to the receiving port of the consumption-side gas tank 33.

In step S12, the plurality of gas pipeline units arranged in step S11 are connected to each other. As a result, the gas pipeline 31 constituted by the plurality of gas pipeline units is completed.

In step S13, the lid 102 for an underground structure described above is disposed in an opening provided in each of the plurality of underground structures 101 and communicating the underground space S1 with the ground space S2.

### Operations of Gas Exhaust System

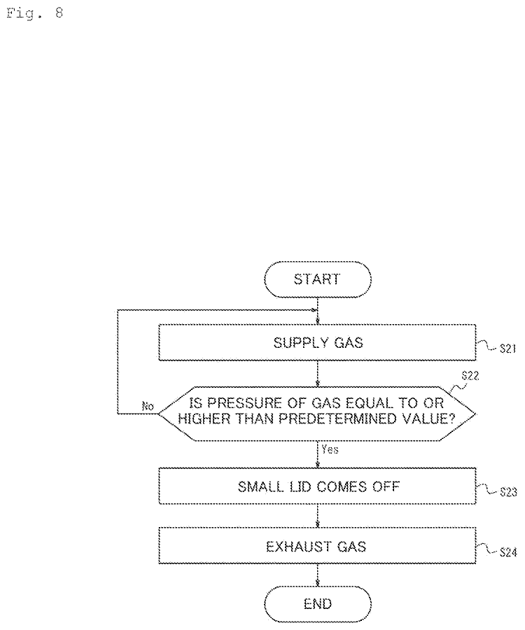

Here, operations of the gas exhaust system 100 according to the present embodiment will be described with reference to FIG. 8. FIG. 8 is a sequence diagram showing an example of the operations of the gas exhaust system 100 according to the present embodiment.

In step S21, the supply-side gas tank 32 supplies gas to the gas pipeline 31.

In a case where the pressure of the gas is less than the predetermined value in step S22, the processing returns to step S21. In a case where the pressure of the gas is equal to or higher than the predetermined value in step S22, the processing proceeds to step S23.

In step S23, the small lid 2 is pulled out from the through-hole HL defined by the main body portion 1 by being pressed by the gas.

In step S24, the small lid 2 is removed from the through-hole HL, the underground space S1 and the ground space S2 are communicated with each other, and the gas is exhausted.

When the gas is exhausted in step S24 and the operation of the gas exhaust system 100 is finished, a manager of the gas pipeline 31 can enter the underground space S1 and to repair the gas pipeline 31. Thereafter, the gas exhaust system 100 can again start the above-described operations.

As described above, according to the present embodiment, the lid 102 for an underground structure includes: the main body portion 1 disposed in the opening provided in the underground structure 101 and communicating the underground space S1 with the ground space S2, the main body portion 1 defining the through-hole HL penetrating the main body portion 1; and the small lid 2 with flexibility that is disposed in the through-hole HL so as to come into pressure contact with the inner surface of the main body portion 1 that defines the through-hole HL. Thus, when the gas leaks from the underground structure 101 and the gas pipeline 31 provided in the pipeline 34 to the underground space S1, the small lid 2 is pushed out to the ground space S2 side by the pressure of the gas, and the underground space S1 and the ground space S2 communicate with each other. Thus, the gas that has leaked from the gas pipeline 31 into the underground space S1 can be quickly exhausted. Therefore, it is possible to avoid, for example, an explosion which may occur when the gas is hydrogen. Since the gas is quickly exhausted from the underground space S1, the worker can safely enter the underground space S1 to repair the damage or the like of the gas pipeline 31 at an early stage. Since the small lid 2 has flexibility, slidability of the small lid 2 to the main body portion 1 is reduced, and thereby, when the gas is not leaking in the underground space S1, the communication between the underground space S1 and the ground space S2 due to the detachment of the small lid 2 from the through-hole HL can be suppressed.

As described above, according to the present embodiment, the through-hole HL includes the first through-hole portion HL1 having the hole diameter Rₕ₁, and the second through-hole portion HL2 adjacent to the first through-hole portion HL1 in the penetration direction and having the hole diameter Rₕ₂ shorter than the hole diameter Rₕ₁, and the small lid 2 includes the inner lid 21 that is disposed in the second through-hole portion HL2 so as come into pressure contact with the inner surface of the main body portion 1 that defines the second through-hole portion HL2, and the outer lid 22 disposed in the first through-hole portion HL1 so as to cover the first through-hole portion HL1 side of the inner lid 21. Thus, the inner lid 21 is pushed out to the ground space S2 side by the pressure of the gas leaked to the underground space S1, and the gas can be exhausted. Further, the inner lid 21 is pushed out to the underground space S1 side by the pressure from the ground space S2 side, suppressing the communication between the underground space S1 and the ground space S2. Further, the outer lid 22 can suppress dust from entering the through-hole HL and the underground space S1, and the inner lid can suppress liquid foreign matter from entering the through-hole HL and the underground space S1.

As described above, according to the present embodiment, the inner lid 21 has the diameter Ria that is shorter than the hole diameter Rₕ₁ and longer than the hole diameter Rₕ₂, and includes the first inner lid portion 21a disposed in the first through-hole portion HL1, and the second inner lid portion 21b that is provided integrally with the first inner lid portion 21a adjacently to the first inner lid portion 21a in the penetration direction and disposed in the second through-hole portion HL2 so as to come into pressure contact with the inner surface defining the second through-hole portion HL2. Thus, the inner lid 21 can be prevented from coming off until the pressure from the underground space S1 side reaches the pressure obtained by gas leakage. Therefore, when the gas is not leaking, the inner lid 21 is removed, and the communication between the underground space S1 and the ground space S2 can be suppressed.

As described above, according to the present embodiment, the flexible projection P1 is provided on the side surface of the second inner lid portion 21b in the direction orthogonal to the penetration direction. Thus, the inner lid 21 can be more surely prevented from coming off until the pressure from the underground space S1 becomes the pressure obtained by gas leakage. Therefore, when the gas is not leaking, the inner lid 21 is removed, and the communication between the underground space S1 and the ground space S2 can be more surely suppressed.

Further, as described above, according to the present embodiment, the outer lid 22 is disposed in the first through-hole portion HL1 so as to come into pressure contact with the inner surface of the main body portion 1 that defines the first through-hole portion HL1. Thus, the outer lid 22 can be prevented from coming off until the pressure from the underground space S1 becomes the pressure obtained by gas leakage. Therefore, when the gas is not leaking, the outer lid 22 is removed, and the inner lid 21 is prevented from being easily removed.

As described above, according to the present embodiment, the flexible projection P2 is provided on the side surface of the outer lid 22 in the direction orthogonal to the penetration direction. Thus, the outer lid 22 can be more surely prevented from coming off until the pressure from the underground space S1 becomes the pressure obtained by gas leakage. Therefore, it is possible to more surely suppress the removal of the outer lid 22 and the removal of the inner lid 21 when the gas is not leaking.

### Supplemental Item 1

A lid for an underground structure, comprising:
a main body portion that covers an opening provided in an underground structure and communicating an underground space with a ground space, and defines a through-hole penetrating the main body portion; and
a small lid with flexibility that is disposed in the through-hole so as to come into pressure contact with an inner surface of the main body portion that defines the through-hole. cl Supplemental Item 2

The lid for an underground structure according to supplemental item 1, wherein the through-hole includes a first through-hole portion having a first hole diameter and a second through-hole portion adjacent to the first through-hole portion in a penetration direction and having a second hole diameter shorter than the first hole diameter, and the small lid includes:
an inner lid that is disposed in the second through-hole portion in such a manner that at least a part of the inner lid comes into pressure contact with the inner surface defining the second through-hole portion; and
an outer lid that is disposed in the first through-hole portion so as to cover the first through-hole portion side of the inner lid.

### Supplemental Item 3

The lid for an underground structure according to supplemental item 2, wherein the inner lid includes:
a first inner lid portion that has a first diameter shorter than the first hole diameter and longer than the second hole diameter and is disposed in the first through-hole portion; and
a second inner lid portion that is provided integrally with the first inner lid portion adjacently to the first inner lid portion in the penetration direction, and is disposed in the second through-hole portion so as to come into pressure contact with the inner surface defining the second through-hole portion.

### Supplemental Item 4

The lid for an underground structure according to supplemental item 3, wherein a first flexible projection is provided on a side surface of the second inner lid portion in a direction orthogonal to the penetration direction.

### Supplemental Item 5

The lid for an underground structure according to any one of supplemental items 2 to 4, wherein the outer lid is disposed in the first through-hole portion so as to come into pressure contact with the inner surface of the body portion that defines the first through-hole portion.

### Supplemental Item 6

The lid for an underground structure according to any one of supplemental items 2 to 5, wherein a second flexible projection is provided on a side surface of the outer lid in the direction orthogonal to the penetration direction.

### Supplemental Item 7

A gas exhaust system comprising an underground structure and a lid for an underground structure, wherein
the lid for an underground structure includes:
a main body portion that covers an opening provided in the underground structure and communicating an underground space with a ground space, and defines a through-hole penetrating the main body portion; and
a small lid with flexibility that is disposed in the through-hole so as to come into pressure contact with an inner surface of the main body portion that defines the through-hole. cl Supplemental Item 8

A gas exhaust system construction method, comprising the steps of:
constructing a gas pipeline that conveys gas from a supply-side gas tank to a consumption-side gas tank, the gas pipeline being partially disposed in a pipeline that communicates a plurality of underground structures with underground spaces defined by the plurality of underground structures respectively; and
arranging the lid for an underground structure described in any one of supplemental items 1 to 6 in an opening provided in each of the plurality of underground structures and communicating the underground spaces with a ground space.

All documents, patent applications, and techniques mentioned in this specification are incorporated herein by reference to the same extent as if each individual document, patent application, or technique were specifically and individually indicated to be incorporated by reference.

Although the above-described embodiment has been introduced as a representative example, it is clear for a person skilled in the art that many alterations and substitutions are possible within the gist and scope of the present disclosure.

Therefore, the present invention should not be interpreted as being limited by the above-described embodiment, and the present invention can be modified and altered in various ways without departing from the scope of the claims.

### REFERENCE SIGNS LIST

1 Main body portion
2 Small lid
21 Inner lid
21a First inner lid portion
21b Second inner lid portion
22 Outer lid
31 Gas pipeline
32 Supply-side gas tank
33 Consumption-side gas tank
34 Pipeline
100 Gas exhaust system
101 Underground structure
102 Lid for underground structure
A Underground
HL Through-hole
HL1 First through-hole portion
HL2 Second through-hole portion
P1 Projection (first projection)
P2 Projection (second projection)
S1 Underground space
S2 Ground space

1. A lid for an underground structure, the lid comprising:
a main body portion that covers an opening provided in the underground structure and communicating an underground space with a ground space, and defines a through-hole penetrating the main body portion; and
a lid portion with flexibility that is disposed in the through-hole so as to come into pressure contact with an inner surface of the main body portion that defines the through-hole.

2. The lid according to claim 1, wherein the through-hole includes a first through-hole portion having a first hole diameter and a second through-hole portion adjacent to the first through-hole portion in a penetration direction and having a second hole diameter shorter than the first hole diameter, and
the lid portion includes:
an inner lid that is disposed in the second through-hole portion in such a manner that at least a part of the inner lid comes into pressure contact with the inner surface defining the second through-hole portion; and
an outer lid that is disposed in the first through-hole portion so as to cover the first through-hole portion side of the inner lid.

3. The lid according to claim 2, wherein the inner lid includes:
a first inner lid portion that has a first diameter shorter than the first hole diameter and longer than the second hole diameter and is disposed in the first through-hole portion; and
a second inner lid portion that is provided integrally with the first inner lid portion adjacently to the first inner lid portion in the penetration direction, and is disposed in the second through-hole portion so as to come into pressure contact with the inner surface defining the second through-hole portion.

4. The lid according to claim 3, wherein a first flexible projection is provided on a side surface of the second inner lid portion in a direction orthogonal to the penetration direction.

5. The lid according to claim 2, wherein the outer lid is disposed in the first through-hole portion so as to come into pressure contact with the inner surface of the main body portion that defines the first through-hole portion.

6. The lid according to claim 5, wherein a second flexible projection is provided on a side surface of the outer lid in a direction orthogonal to the penetration direction.

7. A gas exhaust system comprising:
an underground structure; and
a lid comprising:
a main body portion that covers an opening provided in the underground structure and communicating an underground space with a ground space, and defines a through-hole penetrating the main body portion; and
a lid portion with flexibility that is disposed in the through-hole so as to come into pressure contact with an inner surface of the main body portion that defines the through-hole.

8. A method for constructing a gas exhaust system, the method comprising:
constructing a gas pipeline that conveys gas from a supply-side gas tank to a consumption-side gas tank, the gas pipeline being partially disposed in a pipeline that communicates a plurality of underground structures with underground spaces defined by the plurality of underground structures respectively; and
arranging a lid in an opening provided in each of the plurality of underground structures and communicating the underground spaces with a ground space, the lid including a main body portion that covers the opening and defines a through-hole penetrating the main body portion, and a lid portion with flexibility that is disposed in the through-hole so as to come into pressure contact with an inner surface of the main body portion that defines the through-hole.

9. The method according to claim 8, wherein the through-hole includes a first through-hole portion having a first hole diameter and a second through-hole portion adjacent to the first through-hole portion in a penetration direction and having a second hole diameter shorter than the first hole diameter,
the method further comprising:
disposing an inner lid of the lid portion in the second through-hole portion in such a manner that at least a part of the inner lid comes into pressure contact with the inner surface defining the second through-hole portion; and
disposing an outer lid of the lid portion in the first through-hole portion so as to cover the first through-hole portion side of the inner lid.

10. The method according to claim 9, further comprising:
disposing, in the first through-hole portion, a first inner lid portion of the inner lid that has a first diameter shorter than the first hole diameter and longer than the second hole diameter; and
disposing, in the second through-hole portion, a second inner lid portion of the inner lid that is provided integrally with the first inner lid portion adjacently to the first inner lid portion in the penetration direction, so as to come into pressure contact with the inner surface defining the second through-hole portion.

11. The method according to claim 10, further comprising:
providing a first flexible projection on a side surface of the second inner lid portion in a direction orthogonal to the penetration direction.

12. The lid according to claim 3, wherein the outer lid is disposed in the first through-hole portion so as to come into pressure contact with the inner surface of the main body portion that defines the first through-hole portion.

13. The lid according to claim 12, wherein a second flexible projection is provided on a side surface of the outer lid in a direction orthogonal to the penetration direction.

14. The lid according to claim 4, wherein the outer lid is disposed in the first through-hole portion so as to come into pressure contact with the inner surface of the main body portion that defines the first through-hole portion.

15. The lid according to claim 14, wherein a second flexible projection is provided on a side surface of the outer lid in the direction orthogonal to the penetration direction.
